(19) United States
(12) Patent Application Publication
(10) Pub. No.: US 2014/0202392 A1
(43) Pub. Date: Jul. 24, 2014

(54) COLLAPSIBLE LITTER BOX

(71) Applicant: Jiangsu Zhongheng Pet Supplies Co., Ltd., Jiangsu (CN)

(72) Inventor: Bin QIU, Jiangsu (CN)

(73) Assignee: Jiangsu Zhongheng Pet Supplies Co., Ltd., Jiangsu (CN)

(21) Appl. No.: 14/159,868

(22) Filed: Jan. 21, 2014

(30) Foreign Application Priority Data
Jan. 19, 2013 (CN) ZL201320053893.7

(51) Int. Cl. A01K 1/01

(52) U.S. Cl. CPC A01K 1/0125
USPC 119/165

(57) ABSTRACT

A collapsible cat litter box includes a top cover, a box body, a buckle clasp, and a clasp base engagable with the buckle clasp. The top cover is attached to the box body. The top cover has a plurality of concave grooves. An opening is formed on a central front side of the top cover. The top cover is made from blow molding plastics and is collapsible.

### CROSS REFERENCE TO RELATED APPLICATION

The present application is based on, and claims priority from, Chinese Application Number ZL201320053893.7, filed Jan. 19, 2013, the disclosure of which is incorporated herein in its entirety.

1. Technical Field

The present relates generally to a litter box for pets, and specifically, a collapsible litter box.

2. Background

Pet becomes more and more important in people's life; and the requirement for pet's life quality is also more and more higher. Lots of pet keepers are troubled by the issue of pet's excretion, especially cats' excretion. Most of the existing litter boxes for pets are made by the full-injection molding materials, and have a box shape. Hence, these litter boxes are quite heavy and take a large space. In addition, these litter boxes are not easy for disassembling, folding, storing and transportation, and are associated with quite high transportation costs. Although in some new types of cat litter boxes, the top cover is made of blow molding plastic material to reduce product material, the weights of the new types of cat litter boxes are accordingly decreased, which may make them easy to fall apart when pressed or squeezed. In order to solve these problems, many improvements have been done by many manufacturers. Although certain progresses have been made, they all so far failed to completely solve this simple problem.

### SUMMARY

In order to overcome the aforementioned shortcomings, one or more objects of one or more embodiments of the present disclosure is to provide a collapsible litter box for pets, e.g., cats.

According to one or more embodiments of the present disclosure, the litter box has a buckle clasp on a top cover and a buckle base on a box body. The buckle clasp and the buckle base are configured to be engaged with each other for preventing the litter box from separating apart by the pet when the pet is inside the litter box. The top cover is made from blow molding plastics. The top cover is collapsible such that a volume of the litter box can be reduced to save storage space and reduce the transportation cost when collapsed.

According to one or more embodiments of the present disclosure, the litter box includes a top cover having an opening; a box body; buckle clasps; and clasp bases corresponding to the buckle clasps. The top cover is configured to be attached onto a top of the box body. The top cover has a corrugated structure. The top cover has a plurality of concave grooves. The opening is located at the front center of the top cover. Two buckle clasps are formed on two sides at a bottom of the top cover and two clasp bases corresponding to the two buckle clasps are formed on two side at a top of the box body.

One or more embodiments of the present application provide certain improvements and renovations to the conventional cat litter boxes. The improvements include, but not limited to, providing a top cover made from blow molding plastics and a buckle clasp and a buckle base engagable with the buckle clasp. Such features not only save manufacturing material, but also reduce production costs. The buckle clasp and the buckle base prevent the cat litter box from separating apart by the cat when the cat pushes the top cover accidently. When the litter box is in use, cat litter is disposed in the box body for cat's excretion. When the litter box is not in use or in transportation, the top cover can be folded back to reduce the volume and save space. Hence, the litter box of the present application is easy to be stored, used and transported.

In one or more embodiments of the present application, the litter box is made of different shapes.

### BRIEF DESCRIPTION OF THE DRAWINGS

The present disclosure will be further described in conjunction with drawing figures and embodiments.

FIG. 1 is a perspective view of a first embodiment of a rectangular horizontal- collapsible cat litter box.

FIG. 2 is a perspective view of a second embodiment of a triangular vertical-collapsible cat litter box.

### DETAILED DESCRIPTION

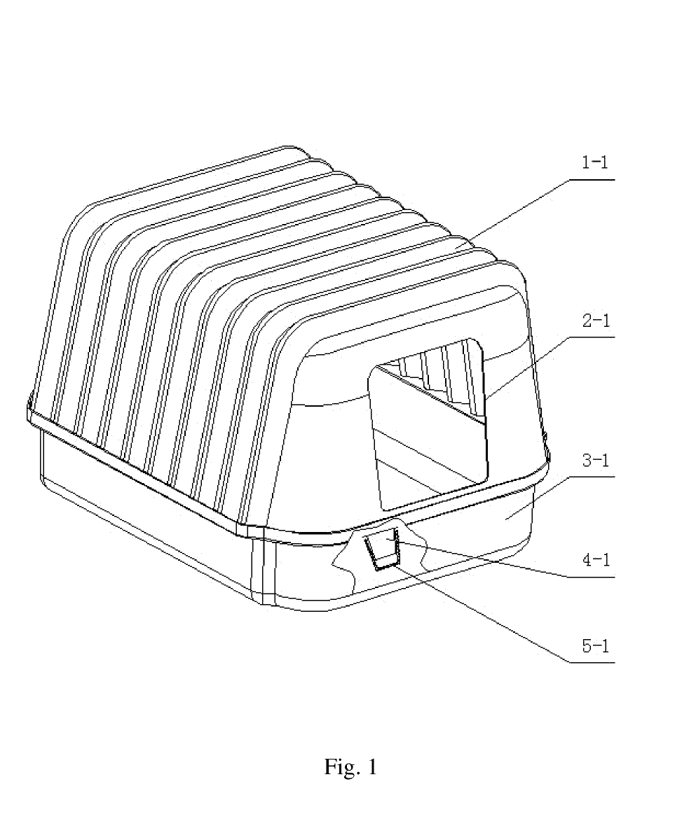

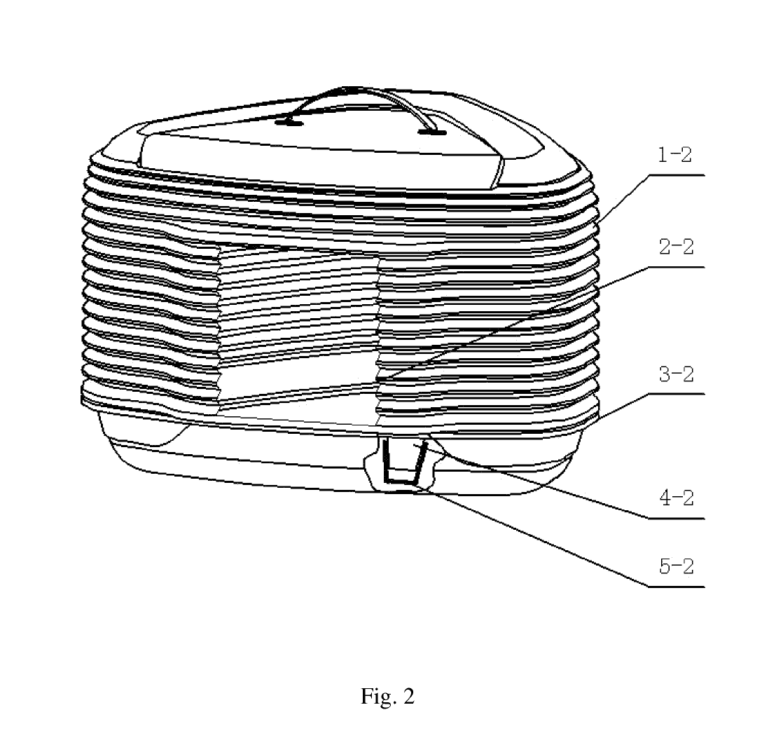

A litter box according to one or more embodiments can be made into various shapes. FIG. 1 shows a first embodiment of a rectangular horizontal-collapsible cat litter box and FIG. 2 shows a second embodiment of a triangular vertical-collapsible cat litter box.

In reference to FIG. 1: the rectangular horizontal-collapsible cat litter box includes a top cover 1-1 having an opening 2-1, a box body 3-1, a buckle clasp 4-1, and a clasp base 5-1. According to FIG. 1, the box body 3-1 and the top cover 1-1 have a substantially rectangular shape having a length direction and a width direction perpendicular to the length direction. A rectangular top cover 1-1 is on top of box body 3-1. In particular, the top cover 1-1 is attachable to the box body 3-1. The top cover 1-1 includes a plurality of grooves extending in the width direction and adjacent to each other in the longitudinal direction.

The opening 2-1 is formed at a center of a front side of the top cover 1-1. However, the opening can be formed at other suitable positions.

Two buckle clasps 4-1 are attached onto the front and back sides of the top cover 1-1, respectively. FIG. 1 shows that the buckle clasp 4-1 is attached onto the front side of the top cover 1-1. The opposite buckle clasp is at the back side of the top cover 1-1 and therefore is not shown in FIG. 1. The buckle clasp 4-1 is an inverted trapezoidal convex body. Two clasp bases corresponding to the buckle clasps 4-1 are formed on front and back sides of box body 3-1, respectively. The clasp base 5-1 is a trapezoidal concave hole for engaging and receiving the inverted trapezoidal convex body of the clasp base 4-1.

According to the embodiment as shown in FIG. 1, the top cover 1-1 is made from blow molded plastic materials. The top cover 1-1 is formed in a single piece. The buckle clasp 4-1 and clasp base 5-1 are attached to the top cover 1-1 and the box-body 3-1, respectively. The buckle clasp 4-1 and the clasp base 5-1 are engagable with each other to secure the top cover and the box body together. The box body 3-1 is configured to store cat litter therein in use. When the litter box is not in use or in transportation, the top cover 1-1 can be horizontally folded back along a front-and-back direction; and the folded top cover can be stored inside the box body 3-1.

In reference to FIG. 2: the triangular vertical-collapsible cat litter box includes a top cover 1-2 having an opening 2-2, a box body 3-2, a buckle clasp 4-2, and a clasp base 5-2. According to FIG. 2, the box body 3-2 has a triangular body. The top cover 1-2 has a triangular shape. The triangular top cover 1-2 is disposed on top of the box body 3-1. The top cover 1-2 has a top wall surface and a side wall connected to the top wall. The side wall of the top cover 1-2 is formed of three segments continuous extending a circumferential direction of the litter box. The side wall is formed with a plurality of grooves extending along the circumferential direction of the litter box. The side wall is collapsible vertically in a thickness direction of the litter box.

The litter box according to embodiment(s) of FIG. 2 further includes a handle fixed to the top cover 1-2.

The opening 2-2 is on the side wall of the top cover 1-2. In particular, FIG. 2 shows that the opening 2-2 is formed at a center of one of the segment of the side wall. The top cover 1-2 further includes two buckle clasps 4-2 attached onto two of the segments of the side wall, respectively. One buckle clasp 4-2 is shown in the perspective view of FIG. 2. The other buckle clasp 4-2 is attached onto another segment of the side wall and is not shown in FIG. 2. The buckle clasp 4-2 has an inverted trapezoidal convex body. The box body 3-2 includes two clasps bases 5-2 corresponding to the two buckle clasps 4-2 of the top cover 1-2, respectively. The clasp base 5-1 is a trapezoidal concave hole.

According to the embodiment as shown in FIG. 2, the top cover 1-2 is made from blow molded plastic materials. The buckle clasp 4-2 and clasp base 5-2 are formed at the top cover 1-2 and the box-body 3-2, respectively. The buckle clasp 4-2 and the clasp base 5-2 are engagable with each other to lock the top cover 1-2 and the box body 3-2 together. The box body 3-2 is configured to store cat litter therein in use. When not in use or in transportation, the top cover 1-2 can be vertically folded back along the top-and-bottom direction.

What is claimed is:

1. A collapsible litter box, comprising:
a top cover having an opening;
a box body attachable to the top cover;
a clasp fixed to the top cover; and
a clasp base provided at the box body and engagable with the clasp,
wherein the top cover is collapsible.

2. The collapsible litter box according to claim 1, wherein the top cover is collapsible in a front-and-back direction of the litter box.

3. The collapsible litter box according to claim 2, wherein said top cover has a side wall having a plurality of grooves that extends in a lateral direction crossing the front-and-back direction of the litter box.

4. The collapsible litter box according to claim 1, wherein the top cover is collapsible in a top-and-bottom direction of the litter box.

5. The collapsible litter box according to claim 4, wherein said top cover has a side wall having a plurality of grooves that extends in a circumferential direction crossing the top-and-bottom direction of the litter box.

6. The collapsible litter box according to claim 1, wherein the top cover is made of blow molding plastic material.

7. The collapsible litter box according to claim 1, wherein the clasp is fixed to a bottom portion of the top cover.

8. The collapsible litter box according to claim 7, wherein the clasp base is formed at a top portion of the box body and configured to engage with the clasp when the box body is secured to the top cover.

9. The collapsible litter box according to claim 1, wherein the top cover further comprises a second clasp and the box body further comprises a second clasp base engagable with the second clasp.

10. The collapsible litter box according to claim 1, further comprising a handle attached to the top cover.

11. The collapsible litter box according to claim 1, wherein the litter box has a rectangular shape.

12. The collapsible litter box according to claim 11, wherein the top cover is collapsible in a front-and-back direction of the litter box.

13. The collapsible litter box according to claim 12, wherein said top cover has a side wall having a plurality of grooves that extends in a lateral direction crossing the front-and-back direction of the litter box.

14. The collapsible litter box according to claim 12, wherein the top cover is collapsible in the front-and-back direction of the litter box only when the top cover is detached from the box body.

15. The collapsible litter box according to claim 1, wherein the litter box has a triangle shape.

16. The collapsible litter box according to claim 15, wherein the top cover is collapsible in a top-and-bottom direction of the litter box.

17. The collapsible litter box according to claim 15, wherein said top cover has a side wall having a plurality of grooves that extends in a circumferential direction crossing the top-and-bottom direction of the litter box.

18. The collapsible litter box according to claim 1, wherein the opening is arranged at a center of a front side of the top cover.

19. The collapsible litter box according to claim 1, wherein the clasp base is a concave hole.

20. The collapsible litter box according to claim 19, wherein the clasp is a convex body engagable with the concave hole of the clasp.
